(19) United States
(12) Patent Application Publication
(10) Pub. No.: US 2021/0317041 A1
(43) Pub. Date: Oct. 14, 2021

(54) TWO-COMPONENT EPOXY CEMENT MORTAR

(71) Applicant: SIKA TECHNOLOGY AG, Baar (CH)

(72) Inventors: Pedro GALLEGOS, Coquimbo (CL); Hugo OLIVARES, Santiago (CL); Luz GRANIZO, Madrid (ES)

(73) Assignee: SIKA TECHNOLOGY AG, Baar (CH)

(21) Appl. No.: 17/272,462

(22) PCT Filed: Sep. 25, 2019
(86) PCT No.: PCT/EP2019/075788

§ 371 Date: Mar. 1, 2021

(30) Foreign Application Priority Data
Oct. 1, 2018 (EP) 18197915.4

(51) Int. Cl. C04B 28/04; C04B 24/12; C04B 24/26; C04B 14/28; C04B 14/06; C04B 40/06

(52) U.S. Cl. CPC C04B 28/04; C04B 24/121; C04B 24/2647; C04B 2103/14; C04B 14/06; C04B 40/065; C04B 14/28

(57) ABSTRACT

A two-component epoxy-modified cement mortar, wherein component A includes cement and an epoxy compound and component B including water and an amine hardener for the epoxy compound, and wherein the epoxy compound includes at least one liquid, water soluble polyepoxide.

### TECHNICAL FIELD

The invention relates to a two-component epoxy-modified cement mortar and its use as rendering, protective coating, screed, patching mortar, corrosion protection, surface sealing, water proofing skim coat and for self-levelling floors.

### BACKGROUND OF THE INVENTION

Epoxy-modified cement mortars are known in construction and repair. They typically comprise three components. One component comprising an epoxy resin, one component comprising a hardener for the epoxy resin and one component comprising cement. Typically, the epoxy resin component is an aqueous emulsion comprising the epoxy resin, typically Bisphenol A and/or F, emulsifying agents and/or reactive diluters and water, the hardener component is an aqueous solution or emulsion comprising an amine hardener and water and the cement component is a powder, comprising cement, filler, aggregates and other powdery additives. The three components are stored in separate containers and are mixed immediately before the application. When mixed, the reaction of the cement with water and the reaction of the epoxy resin with the hardener start, giving eventually a hardened mortar with improved properties.

EP 2 851 353 describes such a multi-component composition.

Epoxy-modified cementitious mortars have several advantages, for example improved adhesion, especially on humid substrates, good water retention capacity and improved freeze-thaw stability.

However, handling three components is economically and ecologically unfavourable. In production three different components must be produced and packed separately, they must be shipped together and mixed in the correct order at job-site. Additionally, a large amount of waste is produced from the packaging material, which must be disposed properly.

The component comprising the cement is a powder and produces dust when added and mixed with the other components. The dust may be harmful and may cause irritations of eyes and skin.

Additionally, emulsifying agents, typically present in the epoxy component, may cause undesired air entrainment and may influence the durability of the hardened mortar.

There have been attempts to reduce the number of components in epoxy-modified cement mortars.

EP 0 409 787 describes a dry composition comprising cement, epoxy resin and hardener. The epoxy resin and the hardener are each mixed separately with a fine solid supporting material before they are combined with the cement.

EP 0 786 439 describes a polymer modified ready-to-use mortar comprising a component comprising cement, epoxy resin and latent hydraulic binder, and another component comprising the amine hardener and filler. The dry components are pre-mixed and stored.

Addition of water to these solid compositions is necessary. This may lead to incorrect dosage of water at the job site. Addition of too low water may lead to poor workability and inhomogeneous mixing whereas a too high amount of water may lead to bleeding, segregation and reduced strength of the hardened material. Additionally, harmful dust may form during handling and mixing which may cause irritation or damage of the worker's skin and eyes or if inhaled.

Furthermore, water must be available at the job site in appropriate quality which may not always be the case.

What is needed is a storage stable, easy to handle epoxy-modified cement mortar without the draw-backs of the current state-of-the-art.

### SUMMARY OF THE INVENTION

It is therefore task of the present invention to provide a storage stable, easy and safely to use two-component epoxy-modified mortar.

It was surprisingly found that this task can be fulfilled by the two-component mortar described in claim 1.

The use of two components instead of three saves packaging material and makes the handling more easy.

Since there is no powder component, the components can be mixed easily and without formation of dust, which is of advantage with regard to safety and health of the user.

The water soluble polyepoxide enables fast and homogeneous mixing of component A with component B and a fast reaction of the epoxy groups with the amine hardener, which is favourable.

Additionally, due to its water solubility, the polyepoxide, which is blended with the cement in component A, does not hinder the reaction of the cement with water when component A and B are mixed.

The water soluble polyepoxide does not need surfactants or emulsifyers typically present in the epoxy component of 3-component epoxy-modified mortars, which is favourable, since surfactants may introduce undesired air and may have negative impact on the water tightness of the hardened mortar.

The two-component mortar is ready-to-use. Thus no further addition of water or other compounds must be added at job site, which is user friendly and avoids failures due to wrong dosage of water or additives.

Further aspects of the invention are subject of further independent claims. Specially preferred embodiments are subject of the dependent claims.

### DETAILED DESCRIPTION OF THE INVENTION

Subject of the invention is a two-component epoxy-modified cement mortar consisting of a component A and a component B, characterized in that component A comprises cement and an epoxy compound, component B comprises water and an amine hardener for the epoxy compound, and wherein the epoxy compound comprises at least one liquid and water soluble polyepoxide.

Component A and component B are stored separately from each other.

The term “water soluble” in this document refers to a property of a material that fully dissolves when 1 g of the material is added to 100 g of distilled water at 20° C. and mixed with the water.

The water solubility of the polyepoxide enables fast and homogeneous mixing of component A with component B and a fast reaction, which is favourable.

Preferably, component A and component B have a liquid to soft pasty consistency at 20° C.

The term “liquid” or “liquid consistency” in this document refers to a property of a solution or suspension that flows freely when poured out of a beaker without any further force than natural gravitation at 20° C.

The term “soft pasty consistency” in this document refers to a property of a suspension that is not free flowing but can easily be shaped or spread, especially by hand.

The epoxy compound may be of technical grade.

Technical grade epoxy compounds typically comprise side products resulting from their production process. Such side products can be epoxy-functional or not. Some typical side products contain chlorine and result from the reaction between epichlorhydrine and hydroxyl groups.

The epoxy compound comprises at least one water soluble polyepoxide.

The term “polyepoxide” refers to a molecule comprising two or more epoxy groups.

Preferably, the epoxy compound is a liquid at 25° C. with a low viscosity.

Preferably, the epoxy compound has a viscosity at 25° C. of below 1500 mPa·s, more preferably below 1000 mPa·s, particularly below 900 mPa·s, especially from 20 to 800 mPa·s, measured with a Höppler falling-ball viscosimeter.

A low viscosity of the epoxy compound enables a better fluidity of component A. Additionally, the mixing of the epoxy compound with the cement is easier and more homogeneous when an epoxy compound with low viscosity is used.

The use of an epoxy compound with such a low viscosity allows for a higher content of cement and/or fillers in component A wherein component A has still liquid to soft pasty consistency.

A high content of cement increases the strength of the hardened material. A high content of filler enables an economical product.

Preferably, the epoxy compound comprises a polyepoxide or a mixture of polyepoxides with an average epoxide functionality of 1.8 to 4, preferably 2 to 3.5, especially 2.2 to 3.

The average functionality of a mixture of polyepoxides or a technical grade of a polyepoxide is calculated as the ratio of mol epoxy groups in the mixture divided by the moles of molecules comprising at least one epoxy group in the mixture.

Preferably, the water soluble polyepoxide is an aliphatic polyepoxide.

Preferably, the water soluble polyepoxide is selected from the group consisting of glycerol polyglycidyl ether, ethoxylated glycerol polyglycidyl ether, diglycerol polyglycidyl ether, ethylene glycol diglycidyl ether, diethylene glycol diglycidyl ether, polyethylene glycol diglycidyl ether, propylene glycol diglycidyl ether, dipropylene glycol diglycidyl ether and polypropylene glycol diglycidyl ether, preferably glycerol polyglycidyl ether, especially glycerol triglycidyl ether.

Such polyepoxides are commercially available, praticularly as Denacol™ (from Nagase America Corp.), Erysis® (from Emerald Performance Materials®) or Grilonit® (from Ems-Chemie).

If a water soluble polyepoxide with an epoxide functionality of 2 is present in the epoxy compound, it is preferably used in combination with a water soluble polyepoxide with an epoxide functionality of more than 2.

Besides at least one water soluble polyepoxide, the epoxy compound can further comprise at least one water emulsifyable polyepoxide. Preferably, the water emulsifyiable polyepoxide is an epoxide resin based on Bisphenol A-, Bisphenol F- or Bisphenol A/F-diglycidyl ether.

In case a water emulsifyable polyepoxide is present in the mortar, the ratio of the mol epoxy groups present in the water soluble polyepoxide to the mol epoxy groups present in the water emulsifyable polyepoxide is preferebly from 20:1 to 1:5, more preferably 15:1 to 1:1, especially 10:1 to 2:1.

If a water emulsifyable polyepoxide is present in the epoxy compound, preferably an emulsifying agent is also present.

Preferably, the mortar is free from emulsifyable but not water soluble epoxide resins.

Preferably, the epoxy compound is free of emulsifying agents.

Preferably, the water soluble polyepoxide is the only epoxide group comprising substance in the mortar.

In such mortars, comprising only water soluble polyepoxides and no water-insoluble substance that comprises epoxide groups, component A, comprising the epoxy compound, and component B, comprising water, can easily and homogeneously be mixed and the mortar hardens fast and homogeneously.

The cement may be any available cement type or a mixture of two or more cement types, for example the cements classified under DIN EN 197-1:Portland cement (CEM I), Portland composite cement (CEM II), blast furnace slag cement (CEM III), pozzolanic cement (CEM IV) and composite cement (CEM V). Cements which are produced according to an alternative standard, for example ASTM C150 for Portland cement types or ASTM C595 for blended hydraulic cements as well as other national standards like the Japanese or the Indian standard, are equally suitable.

Suitable in particular are CEM I Portland cements according to DIN EN 197, as for example Portland cement type I-32.5, 1-42.5, I-42.5 R or I-52.5 or Portland cements according to ASTM C150.

Preferably, the cement is Portland cement, especially white Portland cement.

Preferably, the amine hardener comprises at least one water soluble or water dilutable polyamine suitable to react with epoxy groups of the polyepoxide. The term “polyamine” refers to a molecule comprising two or more amine groups.

The amine hardener comprises preferably at least one polyamine with at least three amine hydrogens.

The term “amine hydrogens” refers to hydrogen atoms that are directly bound to the nitrogen atom of an amine group and are able to react with epoxy groups.

Preferably, the amine hardener contains a mixture of two or more amines selected from the group consisting of aliphatic polyamines with at least three amine hydrogens and amino-functional adducts of these amines or of aliphatic monoamines with epoxides, preferably polyepoxides.

Suitable aliphatic polyamines with at least three amine hydrogens are especially 1,3-pentanediamine (DAMP), 1,5-pentanediamine, 1,5-diamino-2-methylpentane (MPMD), 2-butyl-2-ethyl-1,5-pentanediamine (C11-neodiamine), 1,6-hexanediamine, 2,5-dimethyl-1,6-hexanediamine, 2,2(4),4-trimethyl-1,6-hexanediamine (TMD), 1,7-heptanediamine, 1,8-octanediamine, 1,9-nonanediamine, 1,10-decandiamine, 1,11-undecandiamine, 1,12-dodecandiamine, 1,2-, 1,3- or 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 1-amino-3-aminomethyl-3,5,5-trimethylcyclohexane (isophorondiamine or IPDA), 2(4)-methyl-1,3-diaminocyclohexane, 2,5(2,6)-bis(aminomethyl)bicyclo-[2.2.1]heptane (NBDA), 3(4),8(9)-bis(aminomethyl)tricyclo[5.2.1.0^{2,6}]decane, 1,4-diamino-2,2,6-trimethylcyclohexane (TMCDA), 1,8-menthandiamine, 3,9-bis(3-aminopropyl)-2,4,8,10-tetraoxaspiro[5.5]undecane, 1,3-bis(aminomethyl)benzene (MXDA), 1,4-bis(aminomethyl)benzene, bis(2-aminoethyl)ether, 3,6-dioxaoctan-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl)polytetrahydrofuran, polyoxyalkylendi- or triamines, particularly polyetheramines sold under the brand name Jeffamine® (by Huntsman), 2-aminoethylpiperazin, 3-dimethylaminopropylamine (DMAPA), 3-(3-(dimethylamino)propylamino)propylamine (DMAPAPA), bis(6-aminohexyl)amine (BHMT), diethylenetriamine (DETA), triethylenetetramine (TETA), tetraethylenpentamine (TEPA), pentaethylenhexamine (PEHA) or higher homologues thereof, di-propylenetriamine (DPTA), N-(2-aminoethyl)-1,3-propanediamine (N3-amin), N,N′-bis(3-aminopropyl)ethylenediamine (N4-amin), N,N′-bis(3-aminopropyl)-1,4-diaminobutane, N5-(3-aminopropyl)-2-methyl-1,5-pentanediamine, N3-(3-aminopentyl)-1,3-pentanediamine, N5-(3-amino-1-ethylpropyl)-2-methyl-1,5-pentanediamine or N,N′-bis(3-amino-1-ethylpropyl)-2-methyl-1,5-pentanediamine, or di- or triamines derived from fatty acids such as N-coco-alkyl-1,3-propanediamine, N-oleyl-1,3-propanediamine or N-soyaalkyl-1,3-propanediamine.

Suitable aliphatic monoamines for making adducts are especially 1-butylamine, 2-butylamine, tert.butylamine, 3-methyl-1-butylamine, 3-methyl-2-butylamine, cyclopentylamine, hexylamine, cyclohexylamine, octylamine, 2-ethyl-1-hexyl-amine, benzylamine, 1- or 2-phenylethylamine, decylamine, dodecylamine, tetradecylamine, hexadecylamine, octadecylamine, eicosylamine, docosylamine, so called fatty amines such as cocoalkylamine, C₁₆-C₂₂ alkylamine, soyaalkylamine, oleylamine or tallowalkylamine, further 2-methoxyethylamine, 2-ethoxyethylamine, 3-methoxypropylamine, 3-ethoxypropylamine, 3-(2-ethylhexyloxy)propylamine, 3-(2-methoxy-ethoxy)propylamine, 2(4)-methoxyphenylethylamine, polyoxy-alkylenemonoamines, particularly polyethermonoamines sold under the brand name Jeffamine® (by Huntsman) such as Jeffamine® M-600, Jeffamine® M-1000, Jeffamine® M-2005 or Jeffamine® M-2070.

Suitable epoxides for making adducts are especially
monofuctional epoxides such as alkylglycidylethers, polyethylene or polypropylene glycidylethers, phenylglycidylether, cresylglycidylether or other alkylphenylglycidylethers such as tert.butylphenylglycidylether or nonylphenylglycidylether
polyepoxides such as aromatic epoxy resins, particularly based on Bisphenol A, F, or NF, or di- or tripropylene glycole diglycidylether, or polyethylene or polypropylene diglycidylethers.

A suitable amino-functional adduct is preferably made by the reaction of an excess of the amine with the epoxide, preferably at a temperature in the range of 15 to 120° C., preferably 40 to 120° C., particularly 60 to 100° C.

Such amine hardeners contain preferably water in the range of 10 to 90 weight-%, particularly 20 to 80 weight-%. They are called aqueous or water-based amine hardeners.

Suitable aqueous amine hardeners are commercially available, particularly as Sika® Repair/Sikafloor® EpoCem® Modul B (from Sika), Beckopox® EH 623w or Beckocure® EH 2100w/44WA (both from Allnex), Epilink® 701 (from Evonik), Incorez® 148/700 (from Incorez) or D.E.H.® 804 (from Dow). They can be used as such or in further diluted form with water.

Preferably, the amine hardener is present in the two-component mortar in such an amount that the molar ratio of amine-hydrogens to epoxy groups is in the range of 0.6 to 1.5.

Component A and/or component B may further comprise a mineral filler and/or sand.

The term “mineral filler” refers to a powdery or small sized inorganic material different from cement with a size typically of below 0.5 mm. The type of mineral filler is not limited. It may be an inert material or a latent hydraulic binder. The mineral filler is preferably selected from materials of the group consisting of calcium carbonate, dolomite, titanium dioxide, silica fume, quartz, fly ash, slag and mixtures thereof. Preferred fillers are quartz and calcium carbonate, preferably a mixture of both.

Preferably, the filler has a maximum particle size of 0.5 mm.

It may be of advantage, if the mineral filler or part of the mineral filler is very fine calcium carbonate, especially precipitated calcium carbonate.

It may also be of advantage, if the mineral filler or part of the mineral filler, especially the calcium carbonate, is coated. A suitable coating is for example a coating with a fatty acid.

Such fine filler can help control the rheology of the single components and may improve the physical properties of the mortar after mixing of the components.

The term “sand” refers to a naturally occurring granular material composed of finely divided rock or mineral particles. It is available in various forms and sizes. Examples of suitable sand are quartz sand, limestone sand, river sand or crushed aggregates. Preferably, at least part of the sand is quartz sand or limestone sand or a mixture thereof, especially preferred is quartz sand, since it is chemically inert, strong, available in various sizes and the workability of the composition can be set advantageously.

Preferably, component A and/or component B further comprises a mineral filler and/or sand with a maximal grain size of 5 mm, preferably 4 mm, more preferably 3.5 mm.

For special applications it may be of advantage, if the maximal grain size of the sand is 2 mm, especially 1 mm.

For special applications it may also be of advantage, if the two-component mortar comprises only filler, preferably with a maximum grain size of 0.4 mm, especially 0.2 mm.

This gives a specially fine mortar suitable especially for levelling, sealing and finishing of concrete, mortar or stone surfaces, for coatings and for corrosion protection.

The water is present in component B and is preferably tap water. Preferably, the water in the two-component mortar is present in such an amount to result in a weight ratio of water to cement of 0.25 to 0.8, more preferably 0.35 to 0.65.

Advantageously, the mortar contains further additives. Such additives are preferably selected from dispersing agents, superplasticizers, plasticizers, accelerators, retarders, stabilizers, viscosity modifying agents, shrinkage reducers, air detraining agents, thickeners, light weight aggregates, fibres, colouring agents and chromate reducing agents.

Preferably, the mortar additionally comprises at least one superplasticizer.

The superplasticizer improves the fluidity of the mortar and can reduce the necessary amount of water for a good mortar consistency. This increases the strength of the mortar, which is favourable.

The superplasticizer is preferably an anionic polymer comprising —COOM, —So₂—OM, —OPO(OM)₂ or —PO(OM)₂ groups, with M, independent from each other, being H⁺, an alkali metal ion, an earth alkali metal ion, a di- or trivalent metal ion, an ammonium ion or an organic ammonium group, preferably H⁺ and/or an alkali metal ion.

Preferably, the superplasticizer is a comb-polymer comprising anionic groups and polyalkylene glycol side chains.

The polyalkylene glycol side chains are preferably composed of ethylene glycol and/or propylene glycol. Most preferred are side chains of polyethylene glycol.

Preferably, the comb-polymer comprises carboxylic acid groups (-COOM, with M as defined above) and polyethylene glycol side chains.

Preferably, the molar ratio of anionic groups to side chains is from 0.8:1 to 6:1, more preferably 1:1 to 4:1.

Preferably, the side chains have a molecular weight of 500 to 10'000 g/mol, more preferably 800 to 5'000 g/mol.

It may be of advantage, if more than one length of the side chain is present in the comb-polymer.

The mass averaged molecular weight (M_{w}) of the anionic comb-polymer, measured with SEC against polyethylene glycol standards with 0.1 N NaNO₃ at pH 12 as eluent, is preferably 5'000 to 200'000 g/mol, more preferred 8'000 to 150'000 g/mol, especially preferred 10'000 to 130'000 g/mol, particularly 12'000 to 80'000 g/mol.

Such polymers are special good plasticizers for cementitious compositions.

Surprisingly, the comb-polymer is highly compatible with the epoxy compound in component A, resulting in a homogeneous mixture.

According comb-polymers are for example available from Sika Schweiz AG, Switzerland, under the trade name Sika® ViscoCrete®.

The superplasticizer may be part of component A and/or component B.

Preferably, the superplasticizer is present in component A. In this case, the superplasticizer is preferably used in form of a powder.

The superplasticizer, especially a comb-polymer as described above, may help to increase the ratio of cement to epoxy compound without loss of the easy handling and mixing of component A. This is of advantage for costs and for strength of the hardened mortar.

It may also be advantageous, if the superplasticizer is part of component B. In this case, the superplasticizer is preferably used in form of an aqueous solution. The superplasticizer may increase the fluidity and thus mixing and handling of component B.

It may be of advantage, if the superplasticizer used in component A is different from the superplasticizer used in component B. This may help, to optimize the consistency of both components.

Preferably, the superplasticizer is present in 0.05 to 0.5 weight-%, based on the weight of solid polymer with respect to the combined weight of component A and component B.

It is preferred that a two-component epoxy-modified cement mortar of the present invention is essentially free of synthetic polymer latices having ureido functionality. Such synthetic polymer latices may be selected from acrylic polymer latices, styrene/acrylic copolymer latices, styrene/butadiene copolymer latices, acrylonitrile/butadiene polymer latices, chlorintated vinyl polymer latices, and hydrophobic vinyl acetate copolymer latices. The content of ureido groups in such latices may be from 0.002 0.006 moles of ureido groups per 100 g of latex. It is further preferred that a two-component epoxy-modified cement mortar of the present invention is essentially free of polysiloxanes.

“Essentially free of” means that any such synthetic polymer latices having ureido functionality and/or polysiloxanes are comprised in a two-component epoxy-modified cement mortar of the present invention in not more than 5 weight-%, preferably not more than 1 weight-%, especially not more than 0.1 weight-%, each based on the total weight of said two-component epoxy-modified cement mortar.

A preferred component A comprises cement, epoxy compound and superplasticizer.

A further preferred component A comprises cement, epoxy compound, filler and/or sand and superplasticizer.

Preferably, the weight ratio of cement to epoxy compound is 1.5:1 to 4.5:1, more preferably 1.8:1 to 3.5:1.

Such a ratio shows good consistency and handling of component A and a good balance of inorganic and organic binder for optimal properties of the fresh and hardened mortar.

A high content of epoxide compound with respect to the cement and in the mortar improves water tightness, flexual strength, chemical resistivity and adhesion of the hardened mortar.

Specially preferred is a component A comprising, with respect to the total weight of component A:
60 to 80 weight-% cement, especially Portland cement,
20 to 40 weight-% epoxy compound,
0 to 1 weight-%, preferably 0.2 to 0.9 weight-%, superplasticizer powder, especially a comb-polymer superplasticizer, and
0 to 2 weight-%, other additives.

Surprisingly, such a component A is good storage stable without loosing performance even when stored for several months at elevated temperature, particularly in the range of 30 to 40° C.

A preferred component B consists of amine-hardener, water, filler and/or sand and optional further additives.

Specially preferred is a component B comprising, with respect to the weight of component B:
5 to 20 weight-% amine hardener,
10 to 25 weight-% water,
55 to 85 weight-% filler and/or sand, and
0 to 5 weight-%, preferably 0 to 2 weight-%, further additives.

Preferably, component B has a free flowing consistency, which means, it is self-levelling when poured on a flat surface at 20° C.

Such a component B is easily and homogeneously mixed with component A of the present invention resulting in a homogeneously hardening mortar.

Preferably, the two-component mortar comprises 15 to 35 weight-%, more preferably 18 to 30 weight-%, especially 20 to 25 weight-%, cement, with respect to the combined weight of component A and component B.

Preferably, the two-component mortar comprises 30 to 65 weight-%, more preferably 40 to 60 weight-%, especially 45 to 55 weight-%, mineral filler and/or sand.

In a preferred embodiment of the invention the two-component mortar comprises in component A and component B together
15 to 35 weight-% cement,
5 to 15 weight-% epoxy compound comprising at least one water soluble polyepoxide,
aliphatic polyamine in such an amount to result in a ratio of active amine hydrogen atoms to epoxy functions in the mortar of 0.6 to 1.5,
30 to 65 weight-% mineral filler and/or sand,
0.05 to 0.5 weight-% superplasticizer, preferably a comb-polymer comprising anionic groups and polyalkylene glycol side chains
0 to 5 weight-% additives and
water in an amount to result in a weight ratio of water to cement of 0.25 to 0.8, preferably 0.35 to 0.65,

wherein all weight-% are based on the total weight of component A plus component B.

Components A and B are stored in separate containers. To produce a hardenable mortar, both components are mixed in appropriate ratio to result in a mortar composition as defined above.

Preferably, component A and component B are mixed in a ratio of 1:1 to 1:3.

Due to the fluid to soft pasty consistency, both components can easily be mixed and harden homogeneously. The mixing can be done by hand for small portions, however mixing by a mechanical mixing equipment is preferred, especially for larger volumes.

A further object of the invention is a packaging comprising two separate containers wherein one container comprises component A of the two-component mortar and one container comprises component B of the two-component mortar.

Preferably, component B is packed in a bucket that can be used to mix component B with component A. This saves costs and time.

A further object of the invention is a hardenable mortar obtainable by mixing component A and component B of the two-component mortar.

After mixing, the epoxy-modified mortar can be applied as desired.

Another object of the invention is the use of the hardenable mortar as rendering, protective coating, screed, patching mortar, corrosion protection, surface sealing, water proofing skim coat and for self-levelling floors.

The mortar is especially suited for levelling and finishing of concrete, mortar or stone surfaces.

The mortar may be applied by hand or machine.

A further object of the invention is a hardened body obtained after hardening of the hardenable mortar.

### EXAMPLES

The following examples, without being limitative, illustrate the present invention.

Materials

The white Portland cement was type CEM I 42.5.

The epoxy compound was Grilonit® G 1705, available from Ems-Chemie AG, Switzerland, a technical grade glycerol triglycidyl ether with an epoxy equivalent weight of ca. 143 g/epoxy group.

The comb-polymer was Sika®ViscoCrete®-430 P, available from Sika Schweiz AG, Switzerland, a comb-polymer powder comprising carboxylic acid groups and polyalkylene glycol side chains.

The amine hardener was Beckopox® EH 623w, available from Allnex Belgium SA, a water-based amine hardener containing aliphatic polyamine adducts and 20 weight-% water with an amine-hydrogen equivalent weight of 200 g/mol (as delivered).

The precipitated limestone filler was Winnofil® SPT, available from Solvay Advanced Functional Minerals, Belgium.

### Example 1

TABLE 1
Composition of the two-component epoxy-modified cement
mortar M1

| | | Parts by weight |
|---|---|---|
| Component A1 | White Portland cement | 21.5 |
| | Epoxy compound | 9.0 |
| | Comb-polymer | 0.2 |
| Component B1 | Amine hardener | 8.0 |
| | Tap water | 11.4 |
| | Quartz sand 0-0.2 mm | 45.0 |
| | Precipitated limestone filler | 4.5 |
| | Colouring pigment | 0.5 |

Component A1 and component 131 were prepared by mixing the components according to the composition given in table 1.

Component A1 of mortar M1 had a soft pasty consistency.

Component B1 of mortar M1 was a free flowing suspension.

Storage Stability Test

Two portions of component A1 and two portions of component 131 were prepared and stored at 20° C. and 35° C. for 3 months. The components stored at 20° C. were labelled component A1(20) and component B1(20), the components stored at 35° C. were labelled component A1(35) and component B1(35).

After storage for 3 months no difference in appearance or consistency of component A1(20), component A1(35) or a freshly prepared component A1 was determined.

The same was found for a freshly prepared component B1 and the stored components B1(20) and B1(35).

Application Test

Freshly prepared component A1 and freshly prepared component B1 were mixed with a mechanical mixer for 2 minutes to prepare a mortar with the composition as given in table 1.

Specimens were produced and the strength of the mortar was tested according to ASTM D-695 after 7 days. The compressive strength was 12.8 MPa.

Additionally, a coating with this mortar was applied on a concrete surface.

The bond strength was tested according to ASTM D-7234 after 28 days and was 2.4 MPa.

The shore hardness D, measured according to ASTM D-2240, of the coating was 65.

Component A(20) and component B(20) which had been stored at 20° C. for 3 months were mixed and tested as described above.

In the same way component A(35) and component B(35) which had been stored at 35° C. for 3 months were mixed and tested.

All three mortars, produced from A1 and B1, A(20) and B(20) and A(35) and B(35) showed no difference in workability after mixing and during application.

The compressive strength of the 3 mortars was between 12.5 and 13 MPa and the bond strength of the three mortars was between 2.4 and 2.9 MPa.

1. A two-component epoxy-modified cement mortar consisting of a component A and a component B, wherein component A comprises cement and an epoxy compound, component B comprises water and an amine hardener for the epoxy compound, and wherein the epoxy compound comprises at least one liquid and water soluble polyepoxide.

2. The two-component mortar according to claim 1, wherein component A and component B have a liquid to soft pasty consistency at 20° C.

3. The two-component mortar according to claim 1, wherein the epoxy compound has a viscosity at 25° C. of below 1500 mPa·s, measured with a Höppler falling-ball viscosimeter.

4. The two-component mortar according to claim 1, wherien the epoxy compound comprises a polyepoxide or a mixture of polyepoxides with an average epoxide functionality of 1.8 to 4.

5. The two-component mortar according to claim 1, wherein the water soluble polyepoxide is selected from the group consisting of glycerol polyglycidyl ether, ethoxylated glycerol polyglycidyl ether, diglycerol polyglycidyl ether, ethylene glycol diglycidyl ether, diethylene glycol diglycidyl ether, polyethylene glycol diglycidyl ether, propylene glycol diglycidyl ether, dipropylene glycol diglycidyl ether and polypropylene glycol diglycidyl ether.

6. The two-component mortar according to claim 1, wherein the mortar is free from emulsifyable but not water soluble epoxide resins.

7. The two-component mortar according to claim 1, wherein component A and/or component B further comprises a mineral filler and/or sand with a maximal grain size of 5 mm.

8. The two-component mortar according to claim 1, wherein component A and/or component B further comprises at least one superplasticizer.

9. The two-component mortar according to claim 8, wherein the superplasticizer is present in 0.05 to 0.5 weight-%, based on the weight of solid polymer with respect to the combined weight of component A and component B.

10. The two-component mortar according to claim 1, wherein the weight ratio of cement to epoxy compound is 1.5:1 to /1.5:1, preferably 1.8:1 to 3.5:1. 4.5:1.

11. The two-component mortar according to claim 1, wherein it comprises 15 to 35 weight-%, cement, with respect to the combined weight of component A and component B.

12. The two-component mortar according to claim 1, wherein it comprises in component A and component B together
15 to 35 weight-% cement,
5 to 15 weight-% epoxy compound comprising at least one water soluble polyepoxide,
aliphatic polyamine in such an amount to result in a ratio of active amine hydrogen atoms to epoxy functions in the mortar of 0.6 to 1.5,
30 to 65 weight-% inorganic filler and/or sand,
0.05 to 0.5 weight-% superplasticizer,
0 to 5 weight-% additives and
water in an amount to result in a weight ratio of water to cement of 0.25 to 0.8
wherein all weight-% are based on the total weight of component A plus component B.

13. A hardenable mortar obtainable by mixing component A and component B of the two-component mortar, according to claim 1.

14. A method comprising applying the hardenable mortar according to claim 13 as rendering, protective coating, screed, patching mortar, corrosion protection, surface sealing, water proofing skim coat and for self-levelling floors.

15. The hardened body obtained after hardening of the hardenable mortar according to claim 13.

16. A packaging comprising two separate containers wherein one container comprises component A of the two-component mortar and one container comprises component B of the two-component mortar.
